(19) United States
(12) Patent Application Publication
(10) Pub. No.: US 2013/0034690 A1
(43) Pub. Date: Feb. 7, 2013

(54) SUBSTRATE

(71) Applicants: Bee Khuan Jaslyn Law, Singapore (SG); Hong Yee Low, Singapore (SG); Ming Hua Andrew Ng, Singapore (SG); Ai Yu He, Singapore (SG)

(72) Inventors: Bee Khuan Jaslyn Law, Singapore (SG); Hong Yee Low, Singapore (SG); Ming Hua Andrew Ng, Singapore (SG); Ai Yu He, Singapore (SG)

(73) Assignee: AGENCY FOR SCIENCE, TECHNOLOGY AND RESEARCH, Singapore (SG)

(21) Appl. No.: 13/564,042

(22) Filed: Aug. 1, 2012

Related U.S. Application Data
(60) Provisional application No. 61/513,801, filed on Aug. 1, 2011.

(51) Int. Cl. B32B 3/30

(52) U.S. Cl. 428/141

(57) ABSTRACT

There is provided a substrate comprising an array of non-pillar-shaped nanoformations extending from the surface of the substrate and being arranged to form, between adjacent non-pillar-shaped nanoformations, longitudinally shaped nano-sized depression formations, said nanoformations and said depressions being selected to enable the surface of the substrate to exhibit a higher pinning force relative to the surface of a substrate with an array of pillar-shaped formations.

### TECHNICAL FIELD

The present invention generally relates to a substrate. More specifically, the present invention relates to a substrate that has a surface exhibiting an enhanced ability to pin water to the substrate.

### BACKGROUND

The wettability of a solid surface takes on many important roles and functions in daily life, industry, and agriculture. As such, functional surfaces with unique properties related to wettability have gained much interest in current scientific research.

The ability to retain a well-defined drop of liquid on a substrate may have great technological significance, including the ability to spectroscopically probe a single drop over extended periods of time. The pinning of a water drop for very long times without affecting the properties of molecules dissolved in the water is usually measured in terms of a pinning force. Further to this, the related applications involving concepts of hydrophobicity or hydrophilicity present challenges, especially in attempting to create surfaces that can pin droplets with relatively large contact angles.

Many methods have been developed to modify surfaces such that the properties of wettability are also advantageously changed. In particular, many of these modifications are inspired by nature. For example, many types of leaves, or wings of insects are highly hydrophobic in nature. The study of the micro or nanostructures occurring on these naturally occurring objects have led workers within the field to imitate these structures. For example, the rose petal effect, based on biomimicking of the excellent water pinning property of rose petals has been reported. However, the use of such biotemplates is practically difficult to achieve on a relatively larger scale for commercial purposes.

Various physical and/or chemical means are available in the modification of a surface's wettability. While the physical process of creating texture (e.g. by roughening) can serve to enhance either the hydrophobicity or hydrophilicity of a surface, chemical modification of a surface via the attachment of inorganic or organic compounds may also be adopted. However, such modifications through coated-adhesions or additives may not be fully resistant to environments imparting physical or chemical wear-and-tear.

Physicochemical means have also been put forward to modify the wetting properties of surfaces. These include laser ablation, vapour-deposition (e.g. sputtering techniques), focused ion beam-etching, and photolithography. However, in these techniques, sophisticated equipment requiring relatively large capital inputs, together with restrictions on the size of specimens created are commonly encountered.

There is therefore a need to provide a method that overcomes, or at least ameliorates, one or more of the disadvantages described above. There is a need to provide a method that overcomes, or at least ameliorates, one or more of the difficulties or issues encountered in the currently available means to modify the wetting and droplet-pinning characteristics of a surface will advantageously be suitable for further applications in many industries.

### SUMMARY

In one aspect, there is provided a substrate comprising an array of non-pillar-shaped nanoformations extending from the surface of the substrate and being arranged to form, between adjacent non-pillar-shaped nanoformations, longitudinally shaped nano-sized depression formations, said nanoformations and said depressions being selected to enable the surface of the substrate to exhibit a higher pinning force relative to the surface of a substrate with an array of pillar-shaped formations.

The surface of the substrate may exhibit a pinning force of more than 550 μN relative to a substrate with an array of pillar-shaped formations where water is used as the pinning medium. In one embodiment, the pinning force exhibited is more than 650 μN where water is used as the pinning medium.

Advantageously, the higher pinning force conferred by the non-pillar-shaped nanoformations and the nano-sized depressions permit enhanced water pinning on the substrate as compared to prior art substrates, such as substrates with an array of pillar-shaped formations. Further advantageously, the higher pinning force of the disclosed substrate provides more than 10 times improvement over prior art substrates comprising surfaces replicated from the surface of a “rose petal”.

In an embodiment, the array of non-pillar-shaped nanoformations are an ordered array on the substrate. The ordered array advantageously permits homogenous wetting of the substrate to thereby create a surface tension strong enough to pin a water droplet onto the substrate even when the substrate is tilted upside down.

The non-pillar-shaped nanoformations may have a parabolic shape when viewed in cross-section relative to a horizontal plane of the substrate. Alternatively, the non-pillar-shaped nanoformations may have a conical shape when viewed in cross-section relative to a horizontal plane of the substrate. The non-pillar-shaped nanoformations may also be symmetrical when viewed in cross-section relative to a horizontal plane of the substrate. Advantageously, the disclosed shapes of the non-pillar-shaped nanoformations may provide a capillary effect strong enough to cause a water droplet on the substrate to completely penetrate the nano-sized depressions. Such a strong capillary force causes the water droplet to remain pinned on the substrate.

The disclosed substrate may be a polymer substrate. The polymer substrate may be hydrophilic or hydrophobic. Advantageously, the non-pillar-shaped nanoformations and nano-sized depressions may be formed on different polymer substrates to achieve consistently high pinning forces.

In another aspect, there is provided a method of making a substrate comprising an array of non-pillar-shaped nanoformations extending from the surface of the substrate and being arranged to form, between adjacent non-pillar-shaped nanoformations, longitudinally shaped nano-sized depression formations, the non-pillar-shaped nanoformations and the nano-sized depressions being selected to exhibit a higher pinning force relative to a substrate with an array of pillar-shaped formations, the method comprising: applying a mold having an array of imprint forming structures disposed thereon to the substrate under conditions to form an array of non-pillar-shaped nanoformations and nano-sized depression formations that are complementary to the imprint forming structures.

Advantageously, the non-pillar-shaped nanoformations and the nano-sized depressions are integrally formed from the substrate. Thus, the non-pillar-shaped nanoformations and the nano-sized depressions are more robust than chemical additives added to a substrate to enhance the pinning force as such chemical additives may lose its function over time. Further advantageously, the disclosed method is an environmentally friendly process.

The applying step may be conducted at a temperature that is above the glass transition temperature (Tg) of the substrate. Advantageously, by choosing an applying temperature that is above the Tg of the polymer substrate, the polymer substrate may become molten at this increased temperature such that it is able to flow and conform to the shape of the mold. Hence, nanoformations that are complementary to the imprint forming structures on the mold can be formed or imprinted in the polymer substrate, which can be retained on the substrate once the substrate is cooled down and demolded from the mold.

### DEFINITIONS

The following words and terms used herein shall have the meaning indicated:

The term “pinning force” as used in the context of the present disclosure refers to the force that is necessary to break a drop of liquid, such as water, free of the attractive potential of a surface. The pinning force of a surface depends on the size, shape, orientation and composition of the surface, as well as on the distribution of surrounding defects on the surface.

The terms “pillar” or “pillar-shaped” as used in the context of the present disclosure refer to a substantially upright longitudinal body where the length is much greater than the width (for example, 5 to 10 times greater than the width), and where the width dimension is relatively constant throughout the length dimension.

The term “non-pillar” or “non-pillar-shaped” as used in the context of the present disclosure refer to a body having a length and height dimension in which the width dimension is not constant throughout the length dimension of the formation.

The term “depression” or grammatical variants thereof, refers to a depressed area relative to a planar surface of a substrate or mold (as the case may be). The term “groove” or grammatical variants thereof, refers to a long, narrow depression or channel.

The prefix “nano” as used in the present specification, shall be taken to refer to, unless otherwise specified, any dimensions that are below about 1 μm. The term “nanoformation” as used herein refers to molds or substrates (as the case may be) having features protruding from the surface that have at least one nanoscale dimension.

The term “array” generally refers to multiple numbers of formations distributed within an area and spaced apart, unless otherwise indicated. Formations within an array may not necessarily have the same orientation, unless otherwise indicated.

The term “ordered array” generally refers to the placement of elements in a specified or predetermined pattern where the elements have distinct spatial relationships to one another. Hence, the term “ordered array” generally refers to structures distributed within an area with distinct, specified or predetermined spatial relationships to one another. For example, the spatial relationships within an ordered array may be such that the structures are spaced apart from one another by generally equal distances. Other ordered arrays may use varying, but specified or predetermined, spacings.

The terms “liquidphobic” and “liquidphobicity” when referring to a surface are to be interpreted broadly to include any property of a surface that does not cause a liquid droplet to substantially spread across it. Generally, if the contact angle between a liquid droplet and the surface is greater than 90°, the surface is liquidphobic or exhibits liquidphobicity. Likewise, the terms “hydrophobic” and “hydrophobicity” mean that the surface is liquidphobic or exhibits liquidphobicity when water is the liquid placed thereon. If the contact angle between a water droplet and the surface is greater than 150°, the surface is defined as super-hydrophobic. The terms “liquidphilic” or “liquidphilicity” when referring to a surface are to be interpreted broadly to include any property of a surface that causes a liquid droplet to substantially spread across it. Generally, if the contact angle between a liquid droplet and the surface is smaller than 90°, the surface is liquidphilic. Likewise, the terms “hydrophilic” and “hydrophilicity” mean that the surface is liquidphilic or exhibits liquidphilicity when water is the liquid placed thereon. If the contact angle between a water droplet and the surface is about 0°, the surface is defined as superhydrophilic.

The term “glass transition temperature” (Tg) is to be interpreted to include any temperature of a polymer at which the polymer lies between the rubbery and glass states. This means that above the Tg, the polymer becomes rubbery and can undergo elastic or plastic deformation without fracture. Above this temperature, such polymers can be induced to flow under pressure. When the temperature of the polymer falls below the Tg, generally, the polymer will become inflexible and brittle such that it will break when a stress is applied to the polymer. It should be noted that the Tg is not a sharp transition temperature but a gradual transition and is subject to some variation depending on the experimental conditions (e.g., film thickness, tacticity of the polymer, etc.). The actual Tg of a polymer film will vary as a function of film thickness. The Tg will be defined herein as being the bulk glass-transition temperature of the polymer substrate. The bulk glass transition temperature is a specific value that is widely agreed upon in the literature. Glass transition temperature values of polymers may be obtained from PPP Handbook™ software edited by Dr D. T. Wu, 2000.

The word “substantially” does not exclude “completely” e.g. a composition which is “substantially free” from Y may be completely free from Y. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

### Disclosure of Optional Embodiments

Exemplary, non-limiting embodiments of a substrate comprising an array of non-pillar-shaped nanoformations will now be disclosed.

The substrate comprises an array of non-pillar-shaped nanoformations that extend from the surface of the substrate and are arranged to form, between adjacent non-pillar-shaped nanoformations, longitudinally shaped nano-sized depression formations, the nanoformations and the depressions being selected to enable the surface of the substrate to exhibit a higher pinning force relative to the surface of a substrate with an array of pillar-shaped formations.

The pinning force may be more than about 550 μN, more than about 600 μN, more than about 650 μN or more than 700 μN where water is the pinned medium. In one embodiment, the pinning force may be about 680 μN, 690 μN or 700 μN where water is the pinned medium. The pinning force may be substantially enhanced as compared to other substrates of the prior art which do not have the nanoholes as described herein. The pinning force may be enhanced by at least one time as compared to other substrates. The pinning force may be enhanced by at least two times, at least three times, at least four times, at least five times, at least six times, at least seven times, at least eight times, at least nine times, at least ten times or at least 11 times as compared to a prior art substrate. In one embodiment, the pinning force may be enhanced by at least 11 times as compared to an existing biomimetic structure replicated from the natural “rose petal”.

The pinning force of a liquid droplet can be determined from the equation

F=mg sin α

where α is the sliding angle, or angle of tilt of the surface necessary to produce sliding of the liquid droplet, m is the mass of the liquid droplet and g is the acceleration of gravity (alternatively, mg=weight of the liquid droplet in grams). A schematic illustration of the liquid droplet such as a water droplet on a tilted plane and the related parameters to determine the pinning force is shown in FIG. 2a. As will be mentioned further below, the pinning force can be explained according to the Wenzel model which is based on the assumption that the liquid completely penetrates the holes of the surface (homogeneous wetting). The liquid can enter into the nano-sized depression formations of the substrate surface due to capillary effect such that the capillary force and the large surface tension of the liquid are strong enough to pin the liquid droplet onto its surface without rolling off the surface, even when the substrate is tilted by an angle or flipped upside down.

In order to obtain the high pinning force, the critical weight of the liquid droplet may be more than about 50 mg, more than about 60 mg, more than about 70 mg or more than about 80 mg.

In addition, the pinning of the liquid droplet on the surface of the substrate can be explained further in terms of the three-phase contact line, which refers to the relationship between the solid-vapor, solid-liquid and liquid-vapor surface tension. This can be determined by Young's equation, which gives the relationship between the equilibrium contact angle θ the water droplet makes with the surface and the three surface tensions:

γ_{SV}=γ_{SL}+γ_{LV} cos θ

where γ_{SV}, γ_{SL}, γ_{LV} denotes the solid-vapor, solid-liquid and liquid-vapor surface tension respectively. In the surface of the nano-sized depression formations of the disclosed substrate, the three-phase contact lines are continuous. Thus, the liquid droplet can remain pinned on the surface from the strong capillary force.

The pinning force may be indirectly proportional to the diameter of the nano-sized depression formation, which in turn affects the extent of capillary force generated to pin the liquid droplet on the substrate surface.

The nano-sized depression formations may be arranged in a generally hexagonal array, in a generally square array, in a generally triangle array or any arbitrary shape array. The nano-sized depression formations may be formed between adjacent non-pillar-shaped nanoformations disposed on the substrate. The nano-sized depression formations may be surrounded by at least three non-pillar-shaped nanoformations. The nano-sized depression formations may be surrounded by at least four non-pillar-shaped nanoformations.

The nano-sized depression formations may be in the form of nano-grooves being selected to exhibit a higher pinning force relative to a substrate with an array of pillar-shaped formations. The nano-sized depression formations may extend into the substrate.

The nano-sized depression formations may be spaced apart from each other by a spacing selected from the range of about 200 nm to about 500 nm, about 200 nm to about 250 nm, about 200 nm to about 300 nm, about 200 nm to about 350 nm, about 200 nm to about 400 nm, about 200 nm to about 450 nm, about 250 nm to about 500 nm, about 300 nm to about 500 nm, about 350 nm to about 500 nm, about 400 nm to about 500 nm, about 450 nm to about 500 nm and about 250 nm to about 300 nm.

The non-pillar-shaped nanoformation may have a height selected from the range of about 200 nm to about 500 nm, about 200 nm to about 250 nm, about 200 nm to about 300 nm, about 200 nm to about 350 nm, about 200 nm to about 400 nm, about 200 nm to about 450 nm, about 250 nm to about 500 nm, about 300 nm to about 500 nm, about 350 nm to about 500 nm, about 400 nm to about 500 nm, about 450 nm to about 500 nm and about 250 nm to about 300 nm.

The non-pillar-shaped nanoformation may have a width selected from the range of about 200 nm to about 500 nm, about 200 nm to about 250 nm, about 200 nm to about 300 nm, about 200 nm to about 350 nm, about 200 nm to about 400 nm, about 200 nm to about 450 nm, about 250 nm to about 500 nm, about 300 nm to about 500 nm, about 350 nm to about 500 nm, about 400 nm to about 500 nm, about 450 nm to about 500 nm and about 250 nm to about 300 nm.

Based on the above width and height, the aspect ratio of the non-pillar-shaped nanoformations can be obtained, the aspect ratio being the ratio of the pitch to the height. The aspect ratio may be about 0.4 to about 2.5, about 0.4 to about 0.5, about 0.4 to about 1.0, about 0.4 to about 1.5, about 0.4 to about 2.0, about 0.5 to about 2.5, about 1.0 to about 2.5, about 1.5 to about 2.5 and about 2.0 to about 2.5. The aspect ratio might be about 1.

The non-pillar-shaped nanoformation may have an inter-formation spacing (or “pitch”) selected from the range of about 200 nm to about 500 nm, about 200 nm to about 250 nm, about 200 nm to about 300 nm, about 200 nm to about 350 nm, about 200 nm to about 400 nm, about 200 nm to about 450 nm, about 250 nm to about 500 nm, about 300 nm to about 500 nm, about 350 nm to about 500 nm, about 400 nm to about 500 nm, about 450 nm to about 500 nm and about 250 nm to about 300 nm.

The non-pillar-shaped nanoformations may be symmetrical when viewed in cross-section relative to a horizontal plane of the substrate. The non-pillar-shaped nanoformations may be asymmetrical when viewed in cross-section relative to a horizontal plane of the substrate. The array of non-pillar shaped nanoformations may be an ordered array on the substrate. The ordered array may be generally hexagonal in shape.

The non-pillar-shaped nanoformations may have a parabolic shape when viewed in cross-section relative to a horizontal plane of the substrate. The non-pillar-shaped nanoformations may have a conical shape when viewed in cross-section relative to a horizontal plane of the substrate.

The contact angle of a liquid droplet deposited on the substrate may be more than about 90°. The contact angle of the liquid droplet may be in the range of about 90° to about 150°, about 90° to about 100°, about 90° to about 110°, about 90° to about 120°, about 90° to about 130°, about 90° to about 140°, about 100° to about 150°, about 110° to about 150°, about 120° to about 150°, about 130° to about 150° and about 140° to about 150°. The contact angle may be about 108°, 109° or 114°. Hence, the substrate may be a hydrophobic substrate or a super-hydrophobic substrate.

The substrate may be a polymer substrate although any material that is capable of being imprinted by a mold can be used. The polymer substrate may be a thermoplastic polymer. The thermoplastic polymer may comprise monomers selected from the group consisting of acrylates, phthalamides, acrylonitriles, cellulosics, styrenes, alkyls, alkyls methacrylates, alkenes, halogenated alkenes, amides, imides, aryletherketones, butadienes, ketones, esters, acetals, carbonates and combinations thereof. Exemplary monomers to form the thermoplastic polymer may be selected from the group consisting of methyls, ethylenes, propylenes, methyl methacrylates, methylpentenes, vinylidene, vinylidene chloride, etherimides, ethylenechlorinates, urethanes, ethylene vinyl alcohols, fluoroplastics, carbonates, acrylonitrile-butadiene-styrenes, etheretherketones, ionomers, butylenes, phenylene oxides, sulphones, ethersulphones, phenylene sulphides, elastomers, ethylene terephthalate, naphthalene terephthalate, ethylene naphthalene and combinations thereof.

The polymer substrate may be a polymer composite whereby particles may be added to or incorporated with the polymer. These particles may be selected from the group consisting of calcium carbonate, carbon filler, glass filler, fibers, glass fibers, carbon fibers, carbon nanotubes and mixtures thereof.

The thermoplastic polymer may be hydrophilic or hydrophobic (when in the pristine state, that is, without any imprint structures on the surface). An exemplary hydrophobic thermoplastic polymer may be polydimethylsiloxane (PDMS). An exemplary hydrophilic thermoplastic polymer may be selected from the group consisting of a polystyrene, a polymethyl methacrylate and a polycarbonate. The substrate may not require chemical modification or chemical treatment to alter the wetting property of the substrate. Hence, the wetting property of the substrate may be modified by altering the physical topography of the surface.

The enhanced water pinning property of the substrate may lead to the possibility of using the substrate for the suppression of the “coffee-ring effect”. The “coffee-ring effect” refers to a ring-like stain remaining when a drop of coffee dries on a surface. The physical mechanism underlying the occurrence of the “coffee-ring effect” is due to the pinning of the contact line and the spatially non-uniform evaporation rate of the liquid. Hence, the nanoformations and the depressions may be selected to enable a liquid solution on the surface of the substrate to substantially evaporate uniformly such that the “coffee-ring effect” may be substantially minimized.

The substrate may be made in a method which comprises the step of applying a mold having an array of imprint forming structures disposed thereon to the substrate under conditions to form an array of non-pillar-shaped nanoformations and nano-sized depression formations that are complementary to the imprint forming structures.

The applying step may be conducted at a temperature that is above the glass transition temperature (Tg) of the substrate. The temperature may be about 10° C. to about 100° C. above the Tg of the substrate. By choosing an applying temperature that is above the Tg of the polymer substrate, the polymer substrate may become molten at this increased temperature such that it is able to flow and conform to the shape of the mold. Hence, nanoformations that are complementary to the imprint forming structures on the mold can be formed or imprinted in the polymer substrate, which can be retained on the substrate once the substrate is cooled down and demolded from the mold.

The applying temperature may be selected from the range of about 120° C. to about 200° C., about 120° C. to about 130° C., about 120° C. to about 140° C., about 120° C. to about 150° C., about 120° C. to about 160° C., about 120° C. to about 170° C., about 120° C. to about 180° C., about 120° C. to about 190° C., about 130° C. to about 200° C., about 140° C. to about 200° C., about 150° C. to about 200° C., about 160° C. to about 200° C., about 170° C. to about 200° C., about 180° C. to about 200° C. and about 190° C. to about 200° C. The applying temperature may be about 180° C., which may be about 30° C. above the Tg for a particular polymer substrate.

The applying step may be conducted at a pressure selected from the range of about 10 bars to about 60 bars, about 10 bars to about 20 bars, about 10 bars to about 30 bars, about 10 bars to about 40 bars, about 10 bars to about 50 bars, about 20 bars to about 60 bars, about 30 bars to about 60 bars, about 40 bars to about 60 bars and about 50 bars to about 60 bars. The pressure during the applying step may be about 40 bars.

The applying step may be conducted for a time period selected from the range of about 1 minutes to about 30 minutes, about 1 minutes to about 5 minutes, about 1 minutes to about 10 minutes, about 1 minutes to about 15 minutes, about 1 minutes to about 20 minutes, about 1 minutes to about 25 minutes, about 5 minutes to about 30 minutes, about 10 minutes to about 30 minutes, about 15 minutes to about 30 minutes, about 20 minutes to about 30 minutes and about 25 minutes to about 30 minutes. The applying step may be undertaken for about 5 minutes.

It is to be noted that the above temperature, pressure and time period are guidelines and the person skilled in the art would know what temperature, pressure and time period that can be used for a particular polymer substrate that are sufficient to allow nanoformations to form on the polymer substrate without undue experimentation.

The molds may be made of any suitable material that is chemically inert and may be harder than the softened substrate when used at the respective temperature. The molds may be made of silicon, metal, glass, steel, quartz, ceramic or combinations thereof. The mold may be nickel. The mold may be treated with an anti-stiction agent before being applied to the substrate. The anti-stiction agent may be a silane-based anti-stiction agent.

In order to obtain the substrate, the substrate may be demolded from the mold. The demolding can be undertaken at a temperature which causes solidification of the substrate. Hence, the demolding temperature may be substantially lower than the applying temperature. The demolding temperature may be about 80° C. The application of the anti-stiction agent earlier to the mold may aid in the demolding of the substrate from the mold.

The method may comprise the use of nanoimprinting lithography. The method may result in changing the texture or three-dimensional structure of a surface of a substrate.

The method may result in a roughening of a surface of a substrate.

The method may optionally exclude the step of chemical modifying or treating the substrate surface.

The method may convert a hydrophilic substrate (when not imprinted with the nanoformations) to one which is hydrophobic after being imprinted with the nanoformations.

The mold may be applied onto a specific region of a surface of a substrate to result in localized hierarchical patterns for which modification in the wetting property for that region may be desired.

### BRIEF DESCRIPTION OF DRAWINGS

The accompanying drawings illustrate a disclosed embodiment and serves to explain the principles of the disclosed embodiment. It is to be understood, however, that the drawings are designed for purposes of illustration only, and not as a definition of the limits of the invention.

FIG. 1 is a schematic diagram showing the steps involved in the formation of the substrate.

FIG. 2a to FIG. 2d are illustrations of a water droplet on a tilted plane and the related parameters used in determining the resulting pinning force in a homogeneous wetting process.

FIG. 3a to FIG. 3c show Scanning Electron Microscopy (SEM) images at magnifications of 25,000 times, 30,000 times and 30,000 times, respectively, of nanoimprinted PC substrates obtained from Example 1. The inset of these images show the water droplets for the measurement of contact angles on these substrates. FIG. 3d and FIG. 3e show photographs that depict the water pinning ability of the imprinted sample shown in FIG. 3a.

FIG. 4 shows images depicting the evaporation profile of a water-based solution containing fluorescein molecules on pristine (non-patterned) PC film and PC film with the rose petal-mimetic nanogroove surface.

FIG. 5a and FIG. 5b illustrate the three-phase contact lines of a water droplet on a lotus leaf and nano-groove, respectively.

FIG. 6a to FIG. 6d are SEM images of various topographies developed on PC films obtained from the Comparative Example.

FIG. 7 shows a bar graph of the results in Table 2.

### DETAILED DESCRIPTION OF DRAWINGS

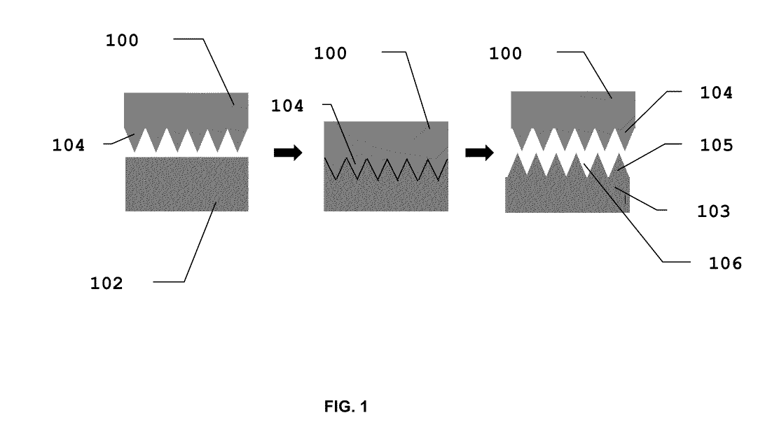

FIG. 1 is a schematic diagram showing the steps involved in the formation of the substrate. A mold 100 having an imprint forming surface 104 and treated with an anti-stiction layer using a self-assembled monolayer coater was placed in contact with a polymer substrate 102 and imprinted at a temperature above the glass transition temperature (Tg) of the polymer 102 at a certain pressure for a period of time. Following this, the temperature of the mold 100 and substrate 102 was cooled down and the mold 100 was demolded from the substrate 102, resulting in a permanently-imprinted substrate 103 having non-pillar-shaped nanoformations 105 extending from the surface of the substrate 103 and being arranged to form, between adjacent non-pillar-shaped nanoformations 105, longitudinally shaped nano-sized depression formations 106.

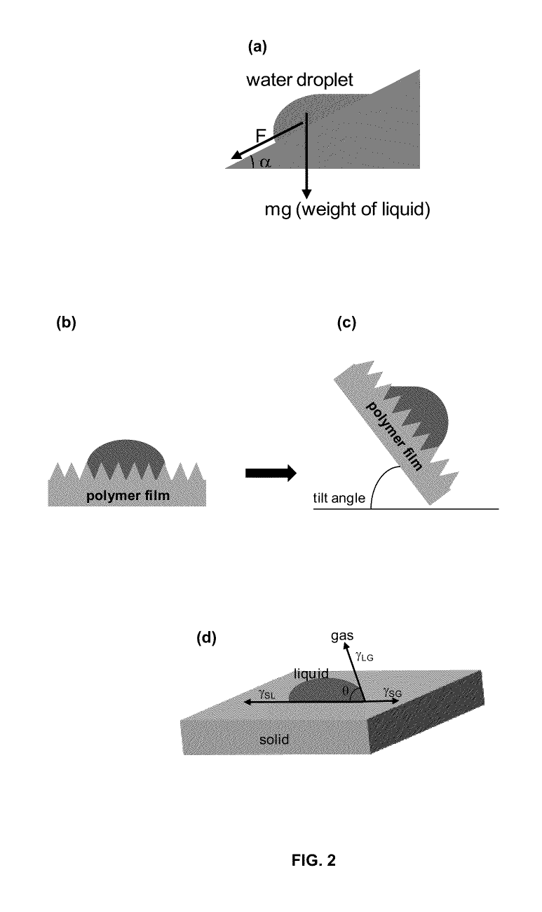

FIG. 2a is a schematic illustration of a water droplet on a tilted plane and the related parameters to determine the pinning force. As mentioned above, the water pinning force on the surface of the fabricated sample was determined from the equation F=(mg sin α). The angle of tilt was fixed at 90° (with the sample placed vertically) and the volume of the water droplet increased (in steps of 1 μL) until the critical weight (or volume) when the droplet slides off the surface in order to determine the pinning force, F (in Newtons, N).

In addition, the water pinning force of the surface can be attributed to similar reasoning for the rose petal effect: the capillary effect and the three-phase (solid-liquid-air) contact line which are both related to the surface topography. The high pinning force can be explained according to the Wenzel model which is based on the assumption that the liquid completely penetrates the grooves of the surface (homogeneous wetting). As illustrated in FIG. 2b, water ingresses into the grooves of the surface due to capillary effect of the conical shaped structure. The capillary force and the large surface tension of water are strong enough to pin the water droplet onto its surface without it rolling off even when the surface is tilted (FIG. 2c) by an angle or flipped upside down.

In contrast to the lotus leaf effect, where the water droplet easily rolls off the surface of the lotus leaf, the water droplet stays pinned onto the surface of the nano-groove structures. This can be further explained in terms of the three-phase contact line. Considering a water droplet on the surface, the droplet forms a shape of spherical cap on the substrate governed by the three surface tensions: solid-liquid, liquid-gas and solid-gas from Young's equation (FIG. 2d). The equation gives the relationship between the equilibrium contact angle θ the water droplet makes with the surface and the three surface tensions as: γ_{SV}=γ_{SL}+γ_{LV} cos θ, where γ_{SV}, γ_{SL}, γ_{LV} denotes the solid-vapor, solid-liquid and liquid-vapor surface tension respectively. This relationship is commonly termed the three-phase contact line. The sliding behavior of the water droplet on the surface is often determined by the three-phase contact line: a continuous contact line is favorable for water pinning.

### EXAMPLES

Non-limiting examples of the invention and a comparative example will be further described in greater detail by reference to specific Examples, which should not be construed as in any way limiting the scope of the invention.

### Example 1

### Controllable-Fabrication of Specific Topography on Commercially-Available Free Standing Polycarbonate (PC) Films

In this example, the process to fabricate a specific topography in accordance with an embodiment of the invention on a PC film as illustrated in FIG. 1 was performed.

A nickel mold with the inverse of the nanoformations was treated with an anti-stiction layer (FDTS, (1H,1H,2H,2H)-perfluorodecyltrichlorosilane) using a self-assembled monolayer coater (AVC, Sorona, Korea) to facilitate easy demolding. The mold was then placed in contact with a PC sheet at a pressure of 40 bars, at an imprinting temperature above the glass transition temperature (Tg) of the polymer for a duration of 5 minutes. For PC films (Tg=150°), the imprinting was performed at 180° C. Following this, the temperature of the system was cooled to 80° C. and demolding was carried out.

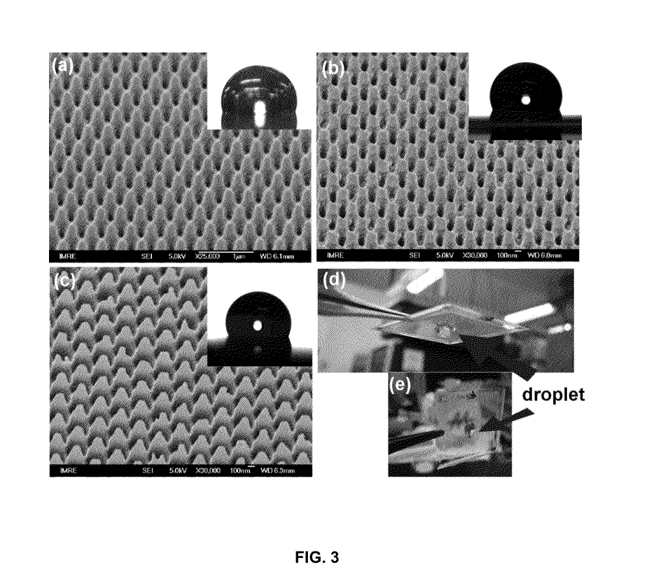

A variety of molds were used to imprint PC films with different topographies using the same method as above. These molds provided variations in pitch/height measurements (250 nm or 300 nm) and profiles (parabolic- or conical-type). SEM images of these different topographies are shown in FIG. 3a to FIG. 3c.

### Example 2

### Characterization of the Fabricated Topographies on Commercially-Available Free Standing Polymer Films Via Contact Angle (CA) Measurements, Scanning Electron Microscopy (SEM), and Determination of Pinning Force

In this example, the characterization of the imprinted substrates in Example 1 was carried out by means of SEM (FE-SEM JSM-6700F, JEOL, Japan) and static water contact-angle (CA) measurements (Rame-Hart, New Jersey, USA).

A deionized (DI) droplet of water (4 μL) was gently dropped onto a sample surface using an automatic pipette, and a photograph of the water droplet was taken immediately with a built-in goniometer camera. The CA values were obtained from the integrated software in the goniometer. For each sample, the average CA measurements was obtained by measuring 5 different locations on the sample. Also, in order to ensure that water CA characterization of the sample is due solely to a topographic effect without any chemical influence, dummy imprints on blank PC specimens were performed on the FDTS-treated mold before imprint on the actual sample. Thus, any physisorbed FDTS on the mold will be transferred to the dummy imprints and will not interfere with the CA measurements and water pinning.

FIG. 3a shows a SEM image of fabricated structures on PC, developed as per Example 1. The synthetic structure consists of a periodic hexagonal array of nano-grooves. Each nano-groove is of “parabolic” profile with a pitch of 300 nm and a height of 300 nm (aspect ratio of 1). This structure exhibits hydrophobicity with a static water contact angle of about 108°±1.4° (inset of FIG. 3a). The synthetic structure of nano-grooves was varied in pitch (FIG. 3b) and profile (FIG. 3c). FIG. 3b shows a SEM image of a fabricated periodic nano-groove structure on PC film with the same parabolic profile as the structure from FIG. 3a, but with a pitch of 250 nm and a height of 250 nm (aspect ratio of 1) while the inset shows its static water contact angle of about 114±3.0°. FIG. 3c shows a SEM image of the fabricated periodic nano-groove structure on PC film with a “conical” profile, and with the same pitch, height and aspect ratio as the structure from FIG. 3a. The static water contact angle is about 109°±4.0° (inset of FIG. 3c). These structures exhibited similar hydrophobicity and good water pinning ability. Table 1 lists the CAs achieved with various developed structures shown in FIG. 3a to FIG. 3c.

TABLE 1

| Indicative | | | | |
|---|---|---|---|---|
| figure of | Pitch | Height | | |
| sample | (nm) | (nm) | Profile | CA (°) |
| 3(a) | 300 | 300 | Parabolic | 108 ± 1.4° |
| 3(b) | 250 | 250 | | 114 ± 3.0° |
| 3(c) | 300 | 300 | Conical | 109 ± 4.0° |

The photographs in FIG. 3d and FIG. 3e show a demonstration of the typical water pinning abilities of the fabricated sample of FIG. 3a. The water droplet (40 μL) is shown to stay pinned onto the surface even when this sample is turned upside down (180°) or tilted vertically to an angle of 90°. To quantify the water pinning property of the nano-groove topographical structures of FIG. 3a to FIG. 3c, the critical weight of the water droplet on a vertical tilted sample (tilt angle)=90° was determined and the pinning force calculated. The three developed samples of nano-grooves exhibited similar water pinning forces: The critical weight of the water droplet on its surface was 69 mg±2 mg, and its corresponding pinning force was approximately 690 μN.

### Example 3

### Suppression of Coffee-Ring Effect in the Evaporation Profile of a Water-Based Solution Containing Fluorescein Molecules on Pristine (Non-Patterned) PC Film and PC Film with the Rose Petal-Mimetic Nanogroove Surface

The enhanced water pinning property of the engineered nanogroove structure leads to the possibility of using these surfaces for the suppression of the “coffee-ring effect”. The “coffee-ring effect” refers to a ring-like stain remaining when a drop of coffee dries on a surface. This is a challenge faced in many practical and industrial applications ranging from coating/printing techniques to microarray analysis where control of a uniform distribution of the solute in an evaporating liquid is needed. Fluorescence microscopy is widely used in microarray techniques where reliability of the readouts to extract meaningful biological signal is highly dependent on the uniform distribution of the spot intensity. The spot-intensity is negatively affected by the non-uniform evaporation rate of a liquid drop, causing an undesirable “ring-like” spot intensity profile artifact in fluorescence spot readout. Elimination of this artifact remains one of the many challenges which needs to be addressed by the biotechnology community. The physical mechanism underlying the occurrence of the “coffee-ring effect” is due to the pinning of the contact line and the spatially non-uniform evaporation rate of the liquid. A number of methods have been proposed to minimize the “coffee-ring’ effect including modifying the capillary flow profile, changing the solvent chemistry, additives or the shape of the solute. Herein, the rose petal-mimetic water-pinning property is used to mitigate the “coffee-ring effect”.

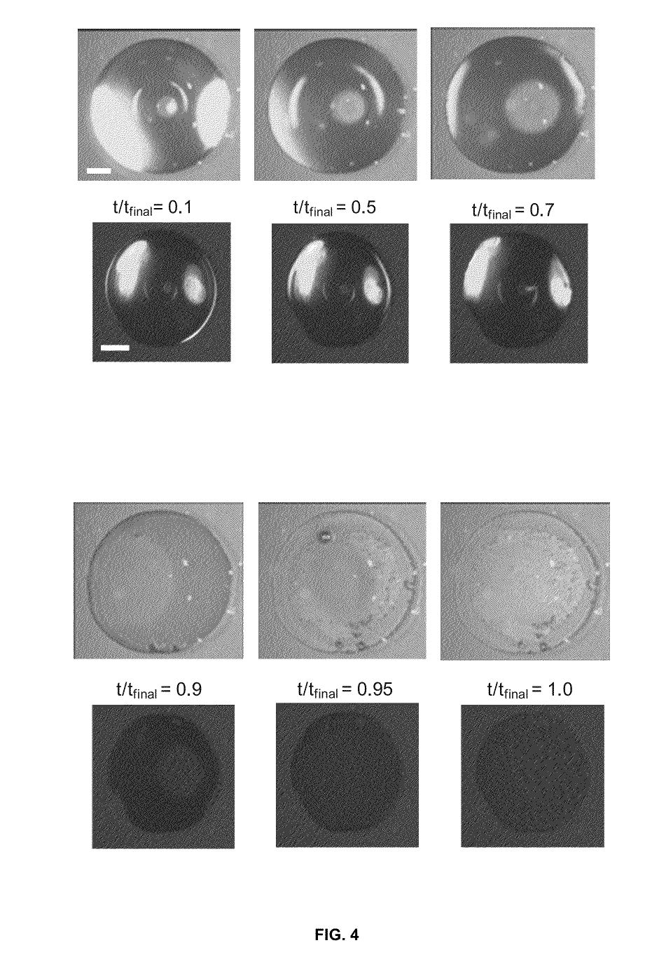

To demonstrate the suppression of the “coffee-ring effect”, the evaporation profile of a water solution containing fluorescein molecule was examined on pristine (non-patterned) PC film and PC film with the rose-petal mimetic nanogroove surface. FIG. 4 shows the evaporating drop images over the time period needed to completely dry the droplet. Because the total time taken to completely dry the droplet is different for the two substrates, the time-frame was normalized for each evaporating profile with respect to the total time taken to completely dry the respective droplet (t_{final}). When the droplets had completely dried (the last image in the time-lapsed images), the ring effect is clearly seen on the non-patterned PC film. It is also common to see a gradient of intensity over the width of the ring. On the contrary, the droplet on the nanogroove surface is a uniformly-colored circular spot.

### Example 4

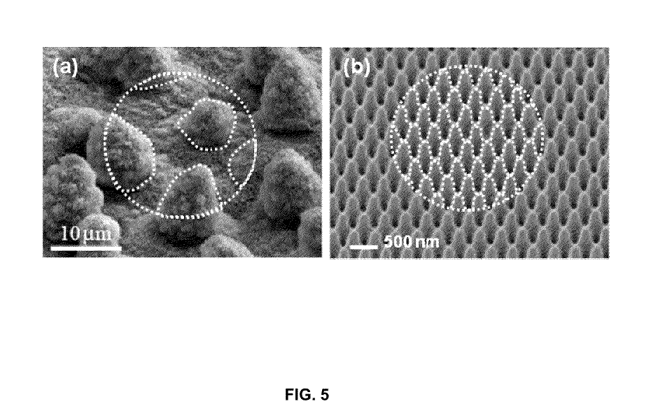

In the case of a lotus leaf, as the surface is made up of random microstructures/nanostructures, the three-phase contact lines are discontinuous (FIG. 5a), which thus prevents water from ingressing into the microstructure interspaces. Therefore, the water droplet does not have a high pinning force on the surface and rolls off easily. In contrast, the surface of the nano-groove in the current invention consists of ordered nanostructures and the three-phase contact lines are continuous (FIG. 5b). Thus, the water droplet remains pinned on the surface from the strong capillary force of the cone-shaped structures.

### Comparative Examples

The pinning force of the substrate having the non-pillar-shaped nanoformations and longitudinally shaped nano-sized depression formations made according to FIG. 1 was compared against other substrates of varying topography.

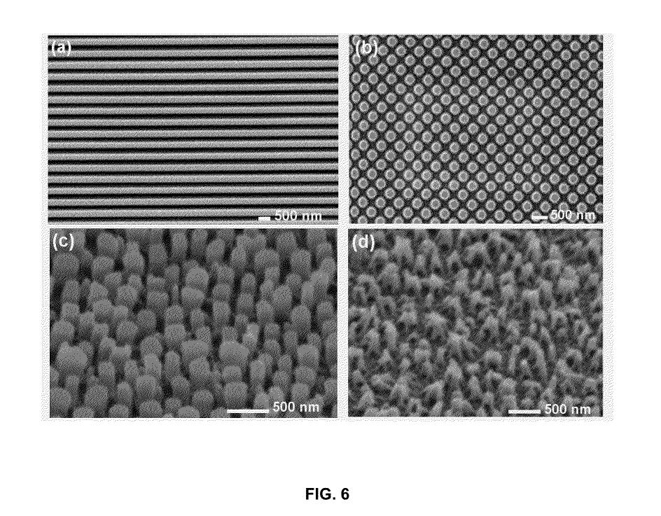

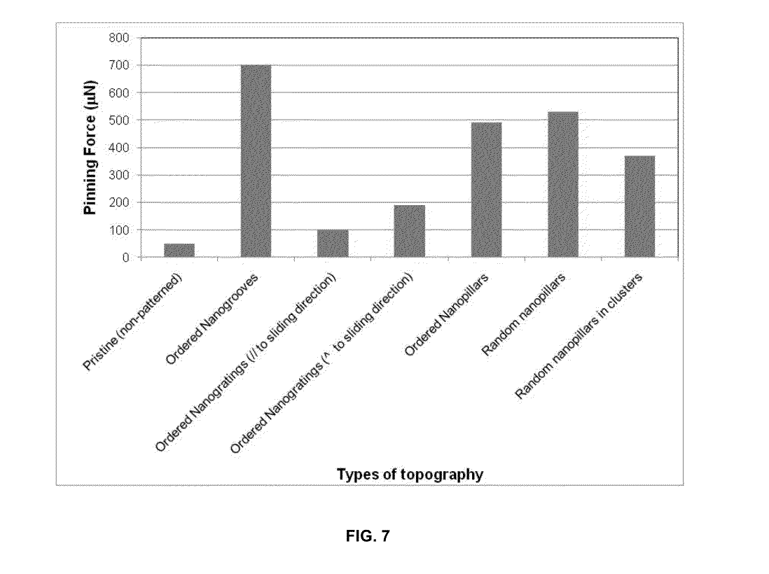

FIG. 6 shows selected SEM images of other fabricated structures on PC films used in the comparison, in addition to those developed in Example 1. FIG. 6a shows a substrate with ordered nanogratings; FIG. 6b shows a substrate with ordered nanopillars (top view); FIG. 6c shows a substrate with random nanopillars (tilted 45°-view); and FIG. 6d shows a substrate with random nanopillars in clusters (tilted 45°-view). The dimensions of these topographies were kept as close as possible in the same order of magnitude as the substrate developed in Example 1 to effect a fair basis of comparison. Table 2 and FIG. 7 lists the comparative values pinning forces obtained in various samples.

The inventors have also compared the pinning force of the substrate against the reported pinning force of the rose petal structure (on polydimethylsiloxane or PDMS) and found that the pinning force of the disclosed substrate is enhanced 11 times that of the rose petal structure.

TABLE 2

| Indicative | | | | | | |
|---|---|---|---|---|---|---|
| figure of | Length | Diameter | Pitch | Height | | Water pinning |
| sample | (nm) | (nm) | (nm) | (nm) | Configuration | force(μN) |
| — | — | — | — | — | Non-patterned | 50 |
| 3a | — | — | 300 | 300 | Ordered | ~700 |
| | | | | | Nanogrooves | |
| 3b | — | — | 250 | 250 | | |
| 3c | — | — | 300 | 300 | | |
| 4a | 250 | — | 500 | 250 | Ordered Nanogratings | 100 (parallel to sliding) |
| | | | | | | 190 (perpendicular to sliding) |
| 4b | — | 250 | 500 | 250 | Ordered Nanopillars | 490 |
| 4c | — | 200 | 400 | 400 | Random Nanopillars | 530 |
| 4d | — | 200 | — | 400 | Random Nanopillars | 370 |
| | | | | | in clusters | |
| — | — | — | — | — | Rose petal structures | 100 |
| | | | | | (replicated on PDMS) | |

### Example 5

### Comparison of Developed Nanogrooves Fabricated on Various Polymers

The nanoformations were imprinted on other substrates such as poly(methyl methacrylate) (or PMMA) and PDMS. Table 3 shows a summary of measured pinning forces exhibited by the materials (PMMA, PC and PDMS) that were patterned. These results indicate that irrespective of the different pristine wettability properties from different materials, the nano-groove topography fabricated on these materials exhibited similar amounts of water pinning forces.

TABLE 3

| | | Reported Pristine | |
|---|---|---|---|
| | Pristine Material | (non-patterned) | Measured Pinning |
| Sample | Wettability | CA (°)* | Force (μN) |
| Nanogroove | Hydrophillic | 71 | 690 |
| topography | | | |
| patterned | | | |
| on PMMA | | | |
| Nanogroove | Hydrophillic | 82 | 700 |
| topography | | | |
| patterned | | | |
| on PC | | | |
| Nanogroove | Hydrophobic | 107 | 680 |
| topography | | | |
| patterned | | | |
| on PDMS | | | |

*adapted from www.accudynetest.com

### Applications

The substrate may not require any chemical modifications or treatment of the surface in order to achieve the liquidphobicity effect. Since the nanoformations are part of the substrate, rather than being deposited or adhered onto the substrate during chemical modifications, the liquidphobicity effect may be retained over a long period of time. This is in contrast to chemical modifications or treatment in which the chemical additives may be used up over time, leading to a loss of the original wetting property. In addition, the chemical, when deposited as a thin-film, may lose its adhesion over time when subjected to harsh environmental conditions such that the original wetting property cannot be sustained over a long period of time. Further, these chemicals may not be environmentally friendly.

The nanoformations may be directly patterned as permanent structures on the surface of the substrate. Advantageously, these nanoformations form part of the substrate and thus are more robust than conventional approach using chemical additives onto the substrates. Since no chemicals are used, they are environmentally green/friendly. Furthermore, the nanoformations can be easily scalable for cost-effective mass manufacturing since they are fabricated by nanoimprinting (e.g. roll-to-roll printing) unlike those reported from replication of rose petals which is limited in practical scalability.

The disclosed substrate may exhibit a high pinning force. When compared to other types of topography (as discussed above), the substrate exhibited the highest water pinning ability.

The presence of the nanoformations may result in the high pinning ability regardless of the wetting property of the non-imprinted polymer substrate. For example, even when the original (non-imprinted) polymer substrate is a liquidphilic one, the presence of the nanoformations confer a liquidphobicity ability to the substrate. The pinning force may be substantially consistent amongst a number of substrates that are initially liquidphilic when non-imprinted.

The substrate may have an anti-drip property and can hence be used in applications which require this property. For example, the substrate can be used in greenhouse film with anti-drip property to minimize water dripping onto the plant in the greenhouse when water condenses on the walls of the greenhouses during sunrise and sunset. Preventing the dripping of water onto plants in greenhouses is essential as water can affect plant quality and growth since it can cause spotting and lead to plant diseases.

Another example of an application which requires this property is on the inside of aircraft walls so as to minimize falling of condensed water droplets onto passengers.

The substrate can be used in microfluidics in the transport of liquid droplets over surfaces by holding the droplets in predetermined location without sliding off.

The substrate can be used in the field of biology such as in proteomics. The ability to pin and confine a small volume droplet on the surface can be useful in proteomics research and development for example, in Matrix Assisted Laser Desorption Ionization (MALDI) support to improve the sensitivity, detection limit and efficiency of the MALDI technique. MALDI utilizes a laser beam of about 100 μm diameter to desorb and ionize protein samples for proteomics research. If a protein/matrix sample can be confined to the 100 μm diameter spot size of the laser without spreading, a 600 times increment in protein concentration would be irradiated by the laser for desorption/ionization, which could lead to improved sensitivity and detection limit in MALDI.

The substrate can also be used in the automotive industry. The substrate can be formulated as an antidrip film in front of the headlamps of cars to enhance reflection during raining. During raining, more raindrops will stay pinned onto the front face of headlamps. These raindrops act as natural reflector lenses when light shines through the front cover of the headlamps. As such, the driving current for the headlamps can be reduced to improve energy efficiency. This natural reflector for the headlamps can be an additional safety feature for visibility for cars during raining.

Hence, the substrate can be used in a number of industries/applications such as in microfluidics, inkjet printing (to control fluid flow), aviation, biology and automotives.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. A substrate comprising an array of non-pillar-shaped nanoformations extending from the surface of the substrate and being arranged to form, between adjacent non-pillar-shaped nanoformations, longitudinally shaped nano-sized depression formations, said nanoformations and said depressions being selected to enable the surface of the substrate to exhibit a higher pinning force relative to the surface of a substrate with an array of pillar-shaped formations.

2. The substrate of claim 1, wherein the pinning force exhibited is more than 550 μN.

3. The substrate of claim 2, wherein the pinning force exhibited is more than 650 μN.

4. The substrate of claim 1, wherein the array of non-pillar-shaped nanoformations are an ordered array on the substrate.

5. The substrate of claim 4, wherein the ordered array is arranged in a shape selected from the group consisting of a generally hexagonal shape, a generally square shape and a generally triangular shape.

6. The substrate of claim 1, wherein the non-pillar-shaped nanoformations have a parabolic shape when viewed in cross-section relative to a horizontal plane of the substrate.

7. The substrate of claim 1, wherein the non-pillar-shaped nanoformations have a conical shape when viewed in cross-section relative to a horizontal plane of the substrate.

8. The substrate of claim 1, wherein the non-pillar-shaped nanoformations are symmetrical when viewed in cross-section relative to a horizontal plane of the substrate.

9. The substrate of claim 1, wherein the nano-sized depressions are in the form of nano-grooves.

10. The substrate of claim 1, wherein the non-pillar-shaped nanoformations have a height dimension of from 200 nm to 500 nm.

11. The substrate of claim 10, wherein the non-pillar-shaped nanoformations have a height dimension of from 250 nm to 300 nm.

12. The substrate of claim 1, wherein the non-pillar-shaped nanoformations have a width of from 200 nm to 500 nm.

13. The substrate of claim 12, wherein the non-pillar-shaped nanoformations have a width of from 250 nm to 300 nm.

14. The substrate of claim 1, wherein the substrate is a polymer substrate.

15. The substrate of claim 14, wherein the polymer substrate is a thermoplastic polymer.

16. The substrate of claim 15, wherein the thermoplastic polymer comprises monomers selected from the group consisting of acrylates, phthalamides, acrylonitriles, cellulosics, styrenes, alkyls, alkyls methacrylates, alkenes, halogenated alkenes, amides, imides, aryletherketones, butadienes, ketones, esters, acetals, carbonates and combinations thereof.

17. The substrate of claim 15, wherein the thermoplastic polymer is hydrophilic or hydrophobic.

18. The substrate of claim 17, wherein the hydrophobic thermoplastic polymer is polydimethylsiloxane (PDMS).

19. The substrate of claim 17, wherein the hydrophilic thermoplastic polymer is selected from the group consisting of a polystyrene, a polymethyl methacrylate and a polycarbonate.

20. The substrate of claim 1, wherein said nanoformations and said depressions are selected to enable a liquid solution on the surface of the substrate to substantially evaporate uniformly.
